(19) United States
(12) Patent Application Publication
(10) Pub. No.: US 2002/0127531 A1
(43) Pub. Date: Sep. 12, 2002

(54) Internet based tutorial system for electronic assembly systems

(76) Inventors: Howard I. Kamens, Stamford, CT (US); Scott A. Pearson, Hopkinton, MA (US)

Correspondence Address: A. Jason Mirabito, Esq., Mintz, Levin, Cohn, Ferris,, Glovsky and Popeo, P.C., One Financial Center, Boston, MA, 02111, US

(21) Appl. No.: 09/802,089

(22) Filed: Mar. 8, 2001

(51) Int. Cl. G09B 3/00

(52) U.S. Cl. 434/350

(57) ABSTRACT

A tutorial software program provides information about the operation of an electronics assembly machine and a computer software interface used to operate the electronics assembly machine. A host transmits the tutorial program over a network, such as the Internet, to a computer at a customer's location. The information provided by the tutorial software program includes pictures representing the computer software interface, text that provides information about the electronics assembly machine and the computer software interface, audio that provides information about the electronics assembly machine, and video that shows the electronics assembly machine in use. Systems and methods for providing the tutorial program are also provided. The tutorial program allows a customer to instruct employees how to fully operate the electronics assembly machine without having to train employees on the machine itself, which could result in costly downtime of the machine.

### FIELD OF THE INVENTION

The present application relates generally to systems and methods for providing tutorial systems. More specifically, it relates to systems and methods for providing Internet based tutorial systems for providing instruction about using electronics assembly machinery.

### BACKGROUND OF THE INVENTION

In the electronics industry, the machinery for assembling the electronics can be very costly. To increase profits, these electronics assembly machines are frequently operated around the clock to maximize their use. Thus, it is commonly difficult to train new personnel on these machines because training may require the machinery to shut down or a trained operator to spend valuable time instructing the inexperienced operator rather than operating the machine.

Computer tutorial systems are well known in the art. A problem with using a tutorial system about operating a piece of machinery is that it is difficult to effectively train someone to use a complex piece of machinery through pictures and text only. Typically, once a student has finished a tutorial, the student must complete further training on the equipment that was the subject of the tutorial. A common example of this is when a student takes a driving education class; it is still necessary to have the student drive a car to become familiar with operating the car. Unlike driving a car which is readily available, it is difficult to provide an effective tutorial for electronics assembly machinery when, as noted above, access to the machinery is expensive and/or cost-prohibitive and these machines are often in operation on a 24/7 basis producing goods. Moreover, the problem of effectively training employees to use electronics assembly machinery is exacerbated when employee turnover is high, which requires employers to more or less constantly train new employees to use the machinery.

### SUMMARY OF THE INVENTION

In one embodiment of the invention, the tutorial software program provides information about the operation of an electronics assembly machine and a computer software interface used to operate the electronics assembly machine. A host transmits the tutorial program over a network or a wide area network such as the Internet to a computer at a customer's location. The information provided by the tutorial software program includes pictures representing the computer software interface, text that provides information about the electronics assembly machine and the computer software interface, audio that provides information about the electronics assembly machine and the computer software interface, and video that shows the electronics assembly machine in use.

In another embodiment of the invention, a system provides a tutorial software program having information about an operation of an electronics assembly machine and a software interface used in conjunction with the operation of the electronics assembly machine, wherein the information is transmitted over the Internet to a computer having an audio interface and a video monitor. The system includes: a remote server computer connected to a network or a wide area network such as the Internet for transmitting information thereover and including a database having information stored thereon relating to pictorial data representing the software interface, and data that provides textual information about the electronics assembly machine and the software interface; and a local storage device connected to the Internet having a database having information stored thereon relating to data that provides audio information about the electronics assembly machine and video data that shows the electronics assembly machine in use. The remote server database can also store data relating to the employee's interaction with the tutorial, such as vitals, quiz scores, etc.

In yet another embodiment of the invention, a method is provided for providing a tutorial software program having information about an operation of an electronics assembly machine and a computer software interface used in conjunction with the operation of the electronics assembly machine, wherein the information is transmitted over the Internet to a computer having an audio interface and a video monitor. The method includes: transmitting to the video monitor pictures representing the software interface, transmitting to the video monitor text that provides information about the electronics assembly machine and the software interface, transmitting through the audio interface audio that provides information about the electronics assembly machine and the software interface, and transmitting to the video monitor video that shows the electronics assembly machine in use.

An advantage of embodiments of the tutorial program is that it allows a customer to instruct employees how to fully operate the electronics assembly machine without having to train employees on the machine itself, which could result in costly downtime of the machine. Another advantage of embodiments of the tutorial program is that because the electronics assembly machine need not be present to train employees, an employer can train employees to use the machine before it has been delivered to the employer. Yet another advantage of embodiments of the tutorial program is that because it is provided over the Internet, customers can easily obtain the tutorial and the host can easily update it.

### BRIEF DESCRIPTION OF THE DRAWINGS

FIG. 1 is a block diagram showing the system for providing Internet based tutorial system in accordance with the invention, where a data storage device is a customer's location.

FIG. 2 is a block diagram showing the system for providing Internet based tutorial system in accordance with the invention, where a data storage device is at a local location.

FIG. 3 is a block diagram showing three educational levels of a sample tutorial and the courses associated with each level.

FIG. 4 is a block diagram of a three sample curriculum paths of the tutorial program.

FIG. 5 is a computer screen showing an overview of a first level of a sample tutorial.

FIG. 6 is a computer screen showing the main menu to a second level of a sample tutorial.

FIG. 7 is a computer screen showing the main menu to a machine operation level of a sample tutorial.

FIG. 8 is a computer screen showing a simulation of a software interface used with an electronics assembly machine.

FIG. 9 is a computer screen that has video of an operator operating an electronics assembly machine.

### DETAILED DESCRIPTION OF THE INVENTION

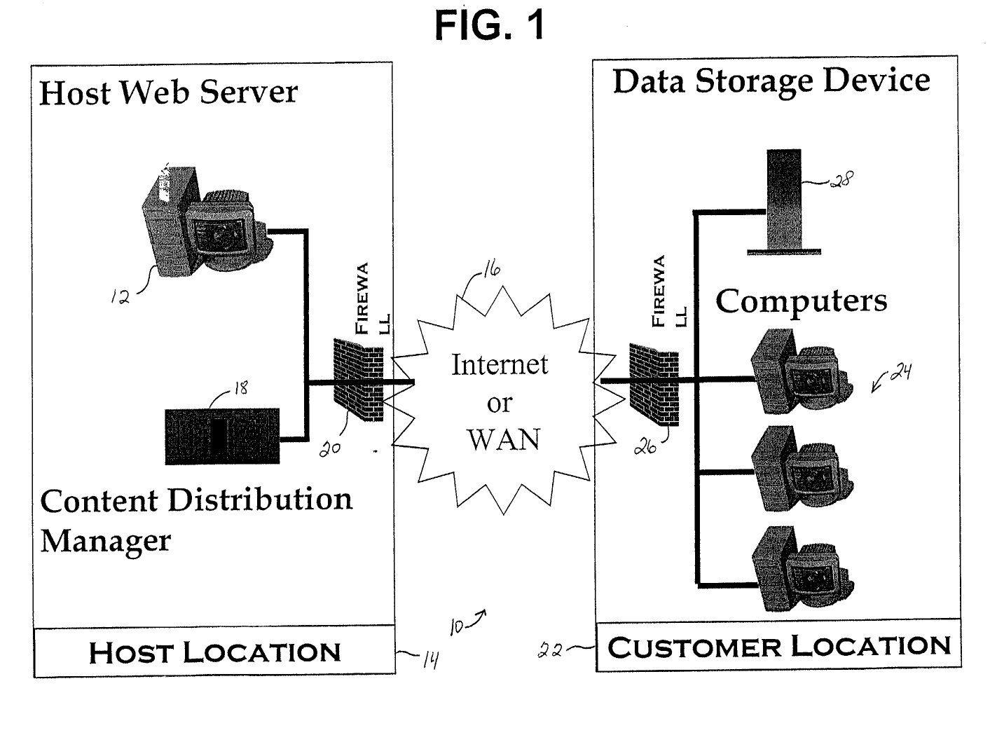

Referring to FIG. 1, one embodiment of the tutorial system 10 includes a web server or data storage device 12 that is located at a host location 14 and connected to the Internet 16 or a wide area network (WAN) and a content distribution manager 18. A firewall 20 is preferably placed between the host's web server 14 and the Internet 16 for data security. At a customer location 22, one or more computers 24 are connected to the Internet 16 or WAN preferably through a firewall 26. In the embodiment of FIG. 1, a data storage device 28 stores data intensive information such as video and audio files and other information if desired such that the data can be retrieved quickly through a high bandwidth connection to the data storage device 28. The content distribution manager 18 at the host location 19 controls the distribution of files on the data storage device 28. Because the content is located at the customer's location, Internet traffic is reduced on the customer's network and the performance of the tutorial system is not effected by the traditional limitations associated with delivering/transmitting media files over the Internet.

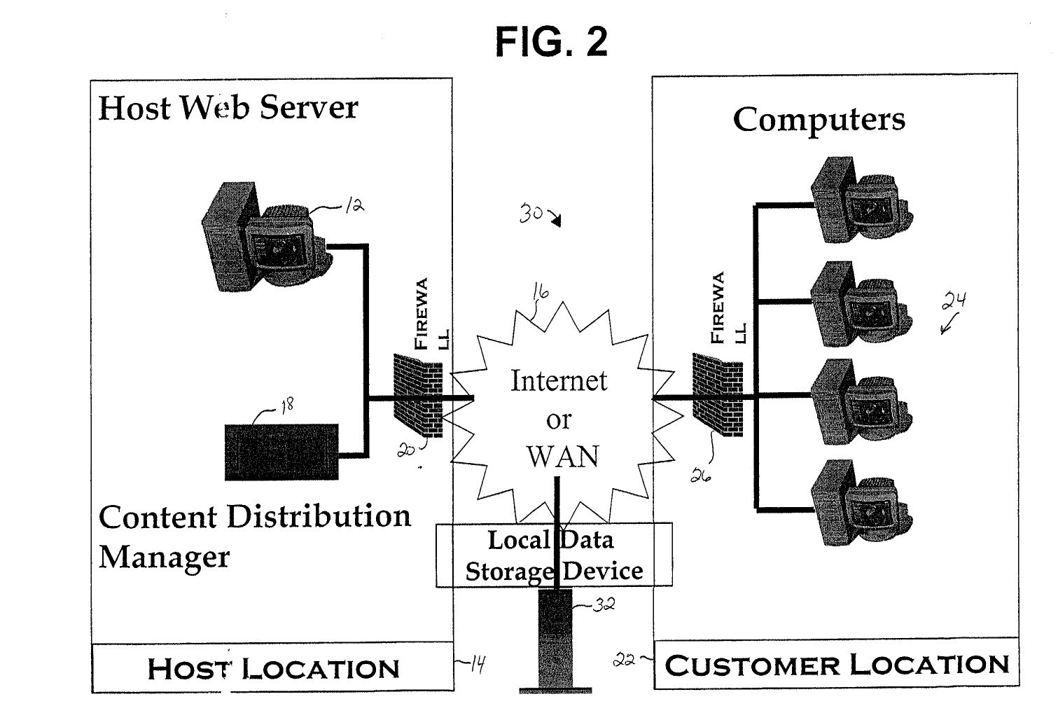

Like the system of FIG. 1, the tutorial system 30 of FIG. 2 includes a web server or data storage device 12 that is located at a host location 14 and connected to the Internet 16 or a wide area network (WAN), a content distribution manager 18 and preferably a firewall 20 for data security. One or more computers 24 are connected to the Internet or WAN preferably through a firewall 26. However, in the tutorial system 30 of FIG. 2, data intensive files, such as video and audio files, are placed on a local server 30 of a vendor. A vendor that can provide a suitable data storage device or server at a location local to the customer is Akamai Technologies, of Cambridge, Mass., which is a distributed hosting partner with worldwide capabilities. The advantage to the tutorial system 32 of FIG. 2 is that the customer does not need to install the server on it's network. However, the disadvantage of having content stored at the vendor location is that the delivery speed to the customer location is limited by the customer's Internet bandwidth 22 and the amount of activity on the customer's Internet connection.

In both the tutorial systems of FIGS. 1 and 2, the one or more computers preferably use Microsoft's Internet Explorer 5.01 as a web browser with SP1, Quicktime 4 and Shockwave 8 added as plugins to the web browser. Quicktime 4 will allow the student to watch video as part of the tutorial. Streaming video may also be used with the present invention, but is not necessary. In both of these embodiments, the application software is located on the host's web server 12 so it is easily updated on the host's server rather than having to update course material on each computer for each customer.

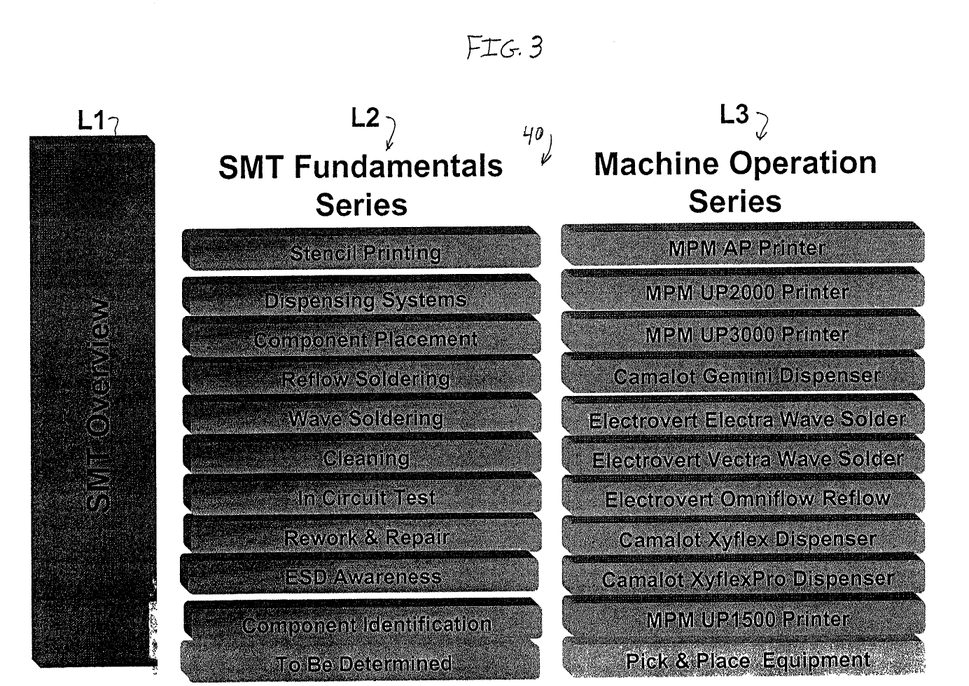

FIG. 3 shows an exemplary block diagram of tutorial courses 40 that a student can take. Typically, a student would begin with a course in the first column L1, proceed to one or more courses in the second column L2, and then finish with one or more courses in the third column L3. In the first column L1, a first level of instruction introduces a student to general material relevant to the subject matter of the courses in the next two columns L2 and L3. For example, the overview of printing in the overview of surface mount technology (SMT) course can be provided as an introduction to the role of a print operator on the electronics assembly line. In the second level of instruction L2, students are presented with in-depth course material relevant to a specific position's responsibilities on the electronics assembly line, such as stencil printing or component placement. The third level of instruction L3 presents machine operation specifics.

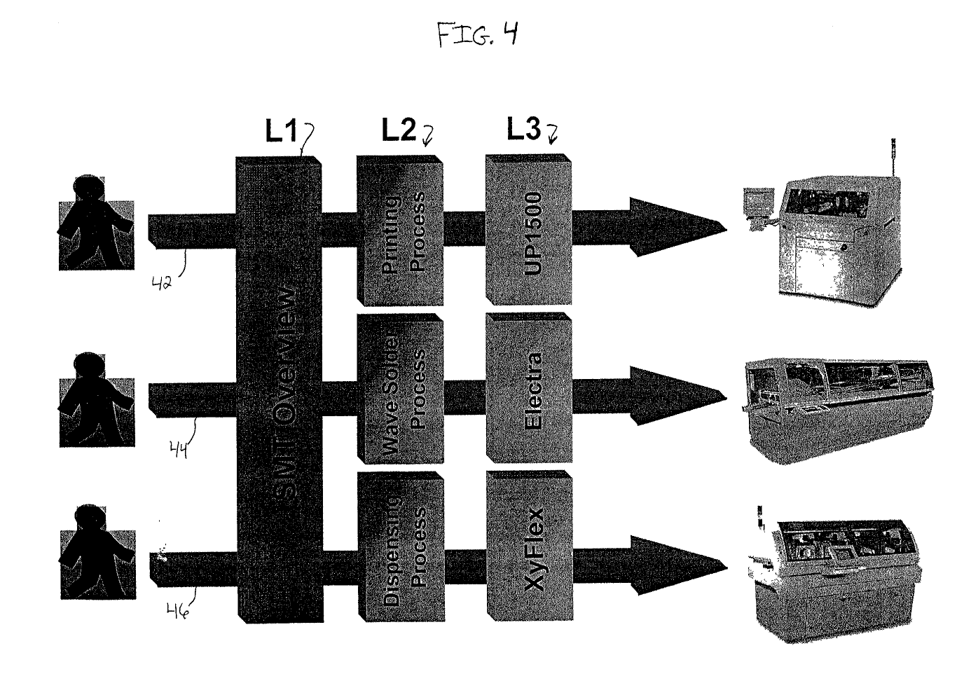

FIG. 4 shows three sample curriculum paths of the tutorial program in which the course material progresses from introductory material to material about the operation of a specific machine. In each of the curriculum paths, the first course is a surface mount technology overview, which is general introductory subject material for each of the machines. In the first path 42, the second lesson is about the stencil printing process and the third lesson is about the operation of the Cookson MPM UP1500 printer. In the second curriculum path 44, the second lesson is about the wave soldering process and the third lesson is about the operation of the Electrovert Electra Wave Solder. In the third curriculum path 46, the second lesson is about the dispensing process and the third lesson is about the operation of the Cookson Camalot Xyflex Dispenser.

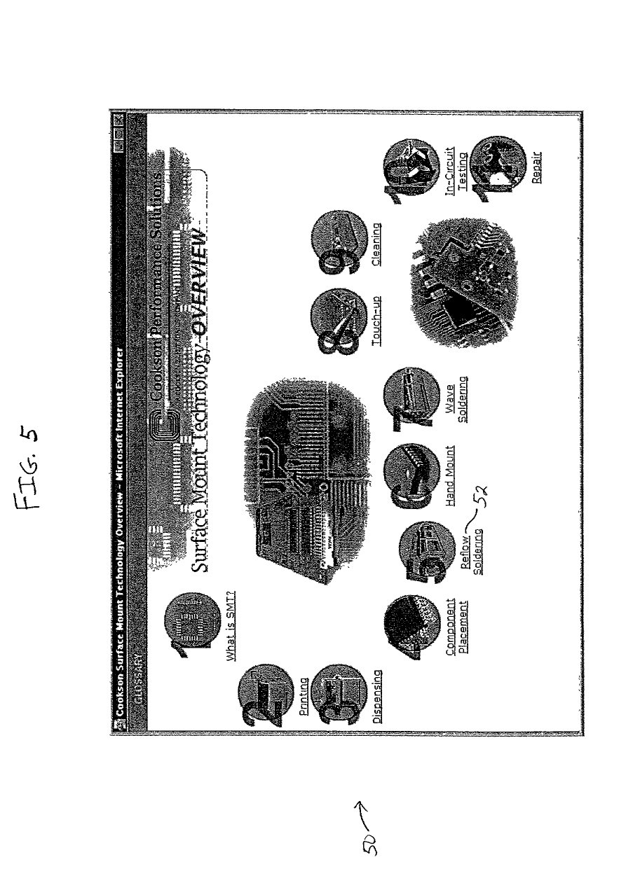

FIG. 5 shows a sample screen display 50 from the surface mount technology overview and each of the stages of the course. Preferably, the host's web server, in a manner well known to those skilled in the art, retains information about each student completing the course as well as the student's progress. Additionally, should a student choose to exit the courseware at any time during a lesson, the system bookmarks the exit location, returning the student to that location when s/he re-enters the course. These features combined offer both students and courseware administrators significant flexibility in tracking and recording vital course-specific student data.

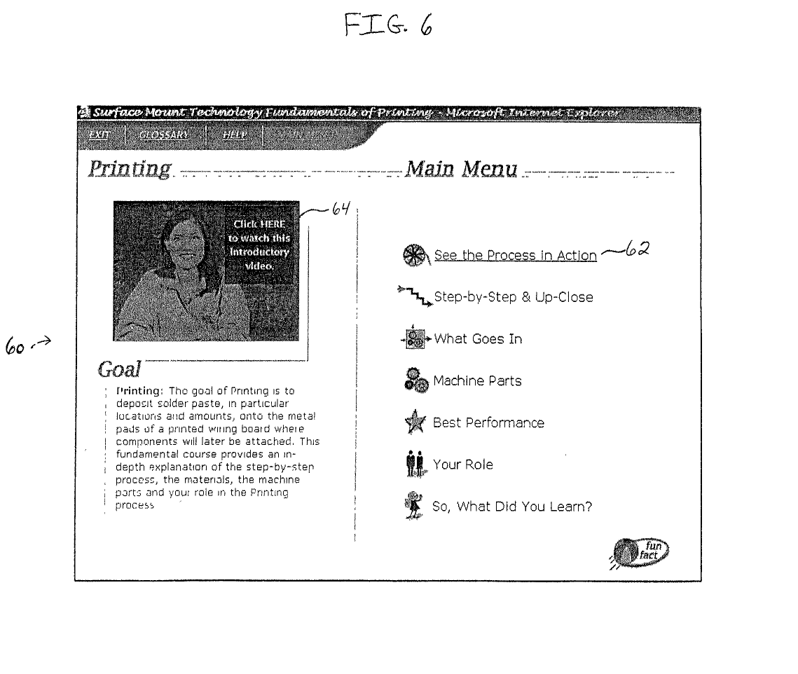

FIG. 6 shows a main menu 60 for the second stage of the surface mount technology overview. By clicking on certain parts of the screen, such as a hyperlink 62 or a video screen 64, again in a manner well known in the art, the student can view video of the printing process and the associated machinery and interact with active images of the various machines. Additionally, the student learns about his or her specific role in operating the machinery. Upon completion of the course, the student is presented with a post-test, designed to assess the student's understanding of the material taught. The scores for level 1 and 2 courseware are stored for student administration purposes.

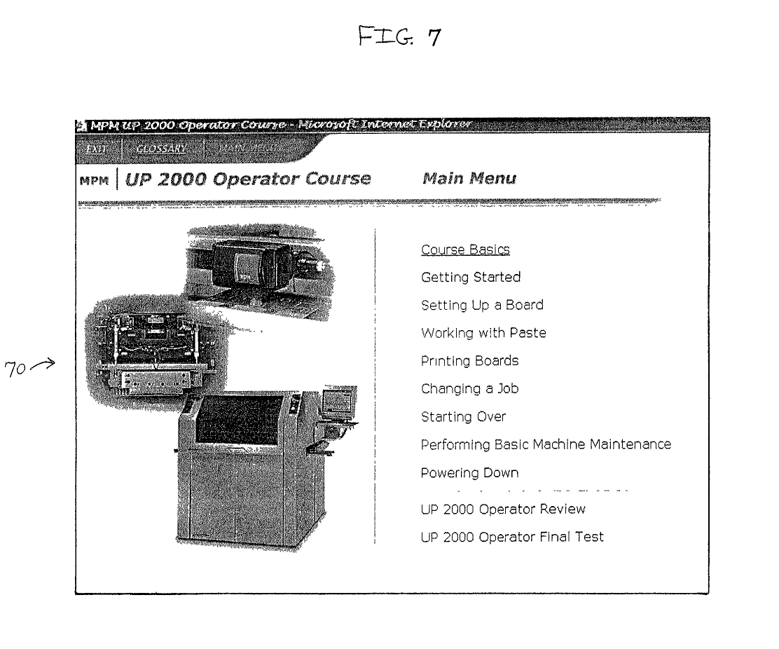

FIG. 7 shows a main menu 70 from an operator course (MPM UP 2000 Printer). The course reviews basic machine operation, such as powering up and down the machine, loading board files, printing boards and performing basic maintenance on the machine.

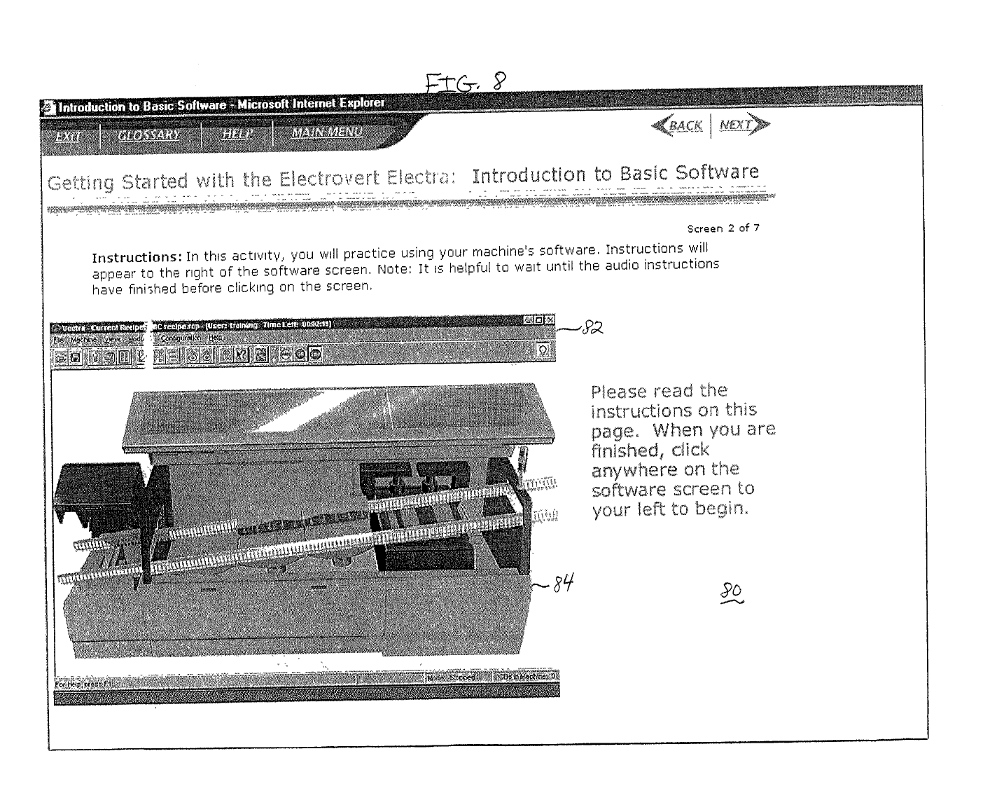

FIG. 8 shows a sample computer screen display 80 in which the tutorial shows a simulation of a software interface used with an electronics assembly machine. In FIG. 8, the electronics assembly machine is the Electovert Electra and the screen shows a simulation of the toolbar 82 of the assembly machine's software interface. An image of the electronics assembly machine 84 is shown in the screen 80. During this lesson, the tutorial guides the student though the use of the machine software interface by allowing the student to click on the toolbar and make toolbar selections as if the student were operating an in-line machine.

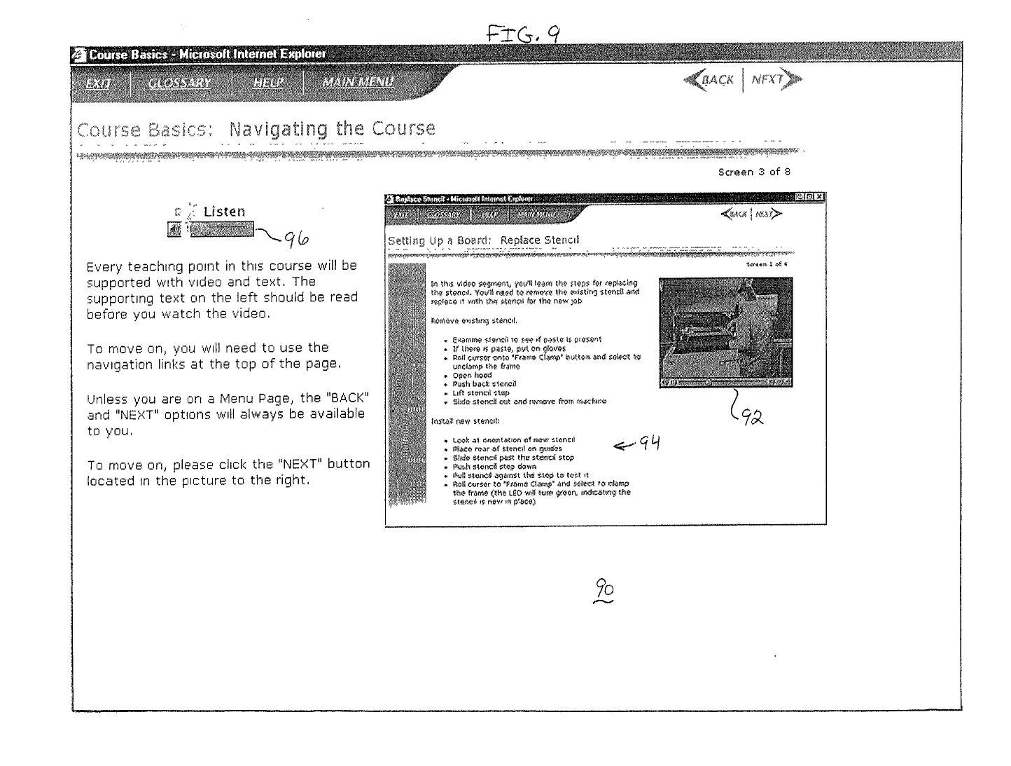

FIG. 9 shows a sample computer screen display 90 in which the instructional video 92 depicts an operator using the machine. The bulleted list on the left side of the screen summarizes the narrated video. For example, in FIG. 9, the operator is replacing a stencil on a machine. The text 94 and audio narration supplements the video depiction. If desired, the audio 96 can repeat the text 94 provided on the tutorial screen or provide additional information such as describing the operator's function shown in the video 92. The use of instructional video is preferred because it can provide immediate images over the Internet of the assembly machine from several viewpoints and perspectives.

Once a student has completed all three levels of the tutorial by completing the training and passing each quiz associated with each level, the system records the results such that student can be later certified as completing the tutorial.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A tutorial software program providing information about an operation of an electronics assembly machine and a software interface used in conjunction with the operation of the electronics assembly machine, the information being transmitted over a computer network to a computer having an audio interface and a video monitor, the information provided by the tutorial software program comprising:
pictures transmitted to the video monitor representing the software interface;
text transmitted to the video monitor that provides information about the electronics assembly machine and the software interface;
audio transmitted through the audio interface that provides information about the electronics assembly machine; and
video transmitted to the video monitor that shows the electronics assembly machine in use.

2. The tutorial software program of claim 1, wherein the information provided by the program further includes a quiz about the operation of the electronics assembly machine.

3. The tutorial software program of claim 1, wherein the video shows an operator using the electronics assembly machine.

4. The tutorial software program of claim 1, wherein the video shows a person talking about the electronics assembly machine and includes audio transmitted to the audio interface of the person talking.

5. The tutorial software program of claim 1, wherein the computer network is the Internet.

6. A system for providing a tutorial software program having information about an operation of an electronics assembly machine and a software interface used in conjunction with the operation of the electronics assembly machine, the information being transmitted over a computer network to a computer having an audio interface and a video monitor, the system comprising:
a remote server computer connected to the Internet for transmitting information thereover and including a database having information stored thereon relating to:
pictorial data representing the software interface; and
data that provides textual information about the electronics assembly machine and the software interface;
a local data storage device connected to the Internet having information stored thereon relating to:
data that provides audio information about the electronics assembly machine; and
video data that shows the electronics assembly machine in use.

7. The system of claim 6, wherein the local data storage device is at a location of a customer.

8. The system of claim 6, wherein the local data storage device is at a location of a vendor.

9. The system of claim 6, wherein the database of the local data storage device further has information stored thereon relating to data representing the software interface.

10. The system of claim 6, further comprising a content distribution manager located at the remote location for controlling access to the data that provides audio information and the video data on the local server computer.

11. The system of claim 6, further comprising the computer having the audio interface and the video monitor.

12. The system of claim 11, further comprising a firewall connected between the computer and the Internet.

13. The system of claim 6, further comprising a firewall connected between the remote server computer and the Internet.

14. The system of claim 6, wherein the third software of claim 1, wherein the computer network is the Internet.

15. A system for providing a tutorial software program having information about an operation of an electronics assembly machine and a software interface used in conjunction with the operation of the electronics assembly machine, the information being transmitted over a computer network to a computer having an audio interface and a video monitor, the system comprising:
a remote server computer connected to the Internet for transmitting information thereover and including a database having information stored thereon relating to: pictorial data representing the software interface; and data that provides textual information about the electronics assembly machine and the software interface;
a local data storage device connected to the Internet having a database having information stored thereon relating to: data that provides audio information about the electronics assembly machine; and video data that shows the electronics assembly machine in use;
the computer having the audio interface and the video monitor;
a content distribution manager located at a location of the remote server for controlling access to the data that provides audio information and the video data on the local server computer; and
a firewall connected between the remote server computer and the Internet.

16. The system of claim 15, wherein the computer network is the Internet.

17. The system of claim 16, wherein the local data storage device is at a location of a customer.

18. The system of claim 16, wherein the local data storage device is at a location of a vendor.

19. A method for providing a tutorial software program having information about an operation of an electronics assembly machine and a software interface used in conjunction with the operation of the electronics assembly machine, the information being transmitted over a computer network to a computer having an audio interface and a video monitor, the method comprising:
transmitting to the video monitor pictures representing the software interface;
transmitting to the video monitor text that provides information about the electronics assembly machine and the software interface;
transmitting through the audio interface audio that provides information about the electronics assembly machine; and
transmitting to the video monitor video that shows the electronics assembly machine in use.

20. The system of claim 19, further comprising transmitting to the video monitor video that shows a person talking about the electronics assembly machine and includes audio transmitted to the audio interface of the person talking.

21. The system of claim 19, further comprising storing the pictorial data representing the software interface and data that provides textual information about the electronics assembly machine and the software interface on a database of a remote server computer connected to the Internet.

22. The system of claim 19, further comprising storing the data that provides audio information about the electronics assembly machine and the software interface and video data on a database of a local data storage device connected to the Internet.
